(19) United States
(12) Patent Application Publication
(10) Pub. No.: US 2024/0375224 A1
(43) Pub. Date: Nov. 14, 2024

(54) BATTERY WELDING SYSTEM FOR ASSEMBLING BATTERY PACK FOR ELECTRIC VEHICLE

(71) Applicants: Hyundai Motor Company, Seoul (KR); Kia Corporation, Seoul (KR)

(72) Inventors: Jongmin Park, Ulsan (KR); Jung Pyo Kim, Ulsan (KR); Seokhyun Cheon, Ulsan (KR); Junhyeok Bae, Ulsan (KR)

(21) Appl. No.: 18/459,542

(22) Filed: Sep. 1, 2023

(30) Foreign Application Priority Data
May 9, 2023 (KR) 10-2023-0059518

(51) Int. Cl. B23K 37/04; B23K 26/21; H01M 10/04

(52) U.S. Cl. CPC B23K 37/04; B23K 26/21; H01M 10/0404; B60L 50/60; H01M 2220/20

(57) ABSTRACT

A battery welding system includes a welding booth, a welding unit installed in an interior of the welding booth and configured to weld a battery component part transported along a predetermined transport path, a component part loading module and a component part unloading module each installed in the interior of the welding booth and configured to load and unload the battery component part at a predetermined part loading position and a part unloading position of the transport path, respectively, and a fire detection unit installed in the welding booth and configured to detect fire occurring in the battery component part.

### CROSS-REFERENCE TO RELATED APPLICATION

This application claims under 35 U.S.C. § 119(a) the benefit of Korean Patent Application No. 10-2023-0059518 filed in the Korean Intellectual Property Office on May 9, 2023, the entire contents of which are incorporated herein by reference.

### BACKGROUND

### (a) Technical Field

The present disclosure relates to a battery welding system, more particularly, to the battery welding system for assembling a battery pack applied to an electric vehicle, the battery welding system being capable of automatically suppressing occurrence of a fire during a battery welding process.

### (b) Description of the Related Art

As demand for electric vehicles increases worldwide, demand for batteries installed in electric vehicles is also increasing.

Since an electric vehicle uses a high-voltage battery composed of a pack of a plurality of rechargeable battery cells as a main power source, there is no exhaust gas and very little noise.

A battery applied to an electric vehicle includes a battery module assembly in which a plurality of battery cells are assembled. Such a battery is mounted on an electric vehicle in the form of a battery pack assembly in which a plurality of battery module assemblies are electrically connected.

Meanwhile, the battery pack assembly may be assembled by a battery assembly system in a battery assembly line. In the battery assembly line, a welding process of stacking battery materials (e.g., battery cells) and laser welding the stacked battery materials (e.g., battery module assemblies) may be performed.

However, in such a battery welding process, a fire may occur in the battery material due to various fire causes such as an electrical short of the battery material, welding heat, and the like.

If a fire occurs in the above battery welding process, the operation of the entire battery assembly line is stopped. Accordingly, the worker manually discharges the component parts on fire in the welding process, and suppresses the fire of the battery material through a separately provided fire extinguishing facility.

Therefore, when a fire occurs in the battery material, since the operator manually discharges the component parts on fire, it takes a lot of time to extinguish the initial fire, which may increase the scale of fire loss of the battery welding facility.

In addition, as the worker manually discharges the component parts on fire and extinguishes the fire, secondary human casualties such as poisoning and burns of the worker due to the fire may be caused.

The above information disclosed in this Background section is only for enhancement of understanding of the background of the disclosure, and therefore it may contain information that does not form the prior art that is already known in this country to a person of ordinary skill in the art.

### SUMMARY

The present disclosure provides a battery welding system capable of extinguishing fire by automatically discharging a battery component part on fire in a welding process of the battery component part.

A battery welding system may include a welding booth (e.g., in which an interior space is formed), a welding unit installed in an interior of the welding booth and configured to weld a battery component part transported along a predetermined transport path, a component part loading module and a component part unloading module each installed in the interior of the welding booth and configured to load and unload the battery component part at a predetermined part loading position and a part unloading position of the transport path, respectively, and a fire detection unit (e.g., installed in the welding booth) configured to detect fire occurring in the battery component part.

The fire detection unit may include at least one flame detecting sensor, at least one smoke detecting sensor, and at least one thermal imaging camera that are installed on an interior surface of the welding booth.

The fire detection unit may further include a CCTV installed on the interior surface of the welding booth.

The battery welding system may further include a fire extinguishing material storage tank installed adjacent to a predetermined part unloading position of the transport path within the interior of the welding booth.

The fire extinguishing material storage tank may include a base portion installed at a bottom in the interior of the welding booth, and a tank portion installed in an upper portion of the base member and configured to store the fire extinguishing material.

The tank portion may be installed in an upper surface of the base portion through at least one support spring.

The tank portion may include a tank main body configured to accommodate the fire extinguishing material, and a pair of tank covers rotatably installed in a vertical direction in an upper portion of the tank main body.

The tank portion may further include a return spring mounted in the tank main body, and connected to the pair of tank covers.

A battery component part on fire may be transported to the predetermined part unloading position through the transport path.

The component part unloading module may be configured to unload the battery component part on fire at the predetermined part unloading position, and to put the battery component part into an interior of the fire extinguishing material storage tank.

A battery welding system may further include a controller configured to apply a control signal to the welding unit and the component part unloading module when it is determined by the fire detection unit that fire has occurred in the battery component part.

The welding unit may be moved to an evacuation position predetermined on the transport path.

A battery component part on fire may be moved to the predetermined part unloading position of the transport path.

The component part unloading module may be configured to grip the battery component part on fire at the predetermined part unloading position, transport the battery component part to the fire extinguishing material storage tank, and put the battery component part into an interior of the fire extinguishing material storage tank.

The controller may be configured to apply the control signal to the welding unit and the component part unloading module when it is determined by manipulation of a fire button that fire has occurred in the battery component part.

A battery welding system may further include a fire extinguishing air bag module installed in the component part unloading module, and configured to receive the control signal from the controller and deploy an air bag.

The welding unit may include a component part pallet that is transported along a main conveyor in the interior of the welding booth, and on which the battery component part is mounted, a clamping jig transported along an auxiliary conveyor in the interior of the welding booth, and configured to clamp the component part pallet, and a welding robot installed in the interior of the welding booth and configured to weld the battery component part on the component part pallet clamped in the clamping jig.

The main conveyor may be disposed to penetrate the welding booth along the predetermined transport path.

The auxiliary conveyor may be disposed in parallel with the main conveyor in the interior of the welding booth.

The component part loading module may be configured to transport the component part pallet transported along the main conveyor to the clamping jig on the auxiliary conveyor.

The component part unloading module may be configured to transport the battery component part on which a welding process is completed on the auxiliary conveyor by the welding robot to the main conveyor together with the component part pallet.

The auxiliary conveyor may be provided in the interior of the welding booth in a quantity of at least two.

A system for assembling a battery pack for an electric vehicle may include the battery welding system.

According to embodiments of the disclosure, the initial extinguishing time of battery component parts may be shortened, the loss scale of the battery welding equipment and the battery production volume due to the fire may be reduced, and the non-operating time of the system may be shortened.

Other effects that may be obtained or are predicted by an embodiment will be explicitly or implicitly described in a detailed description of the present disclosure. That is, various effects that are predicted according to an embodiment will be described in the following detailed description.

### BRIEF DESCRIPTION OF THE DRAWINGS

The drawings are intended to be used as references for describing the embodiments of the present disclosure, and the accompanying drawings should not be construed as limiting the technical spirit of the present disclosure.

FIG. 1 is a block diagram schematically illustrating a battery welding system according to an embodiment.

FIG. 2 is a perspective view showing a battery welding system according to an embodiment.

FIG. 3 is a perspective view showing a component part pallet of a welding unit applied to a battery welding system according to an embodiment.

FIG. 4 is a perspective view showing an auxiliary conveyor of a welding unit applied to a battery welding system according to an embodiment.

FIGS. 5 and 6 are perspective views showing a clamping jig of a welding unit applied to a battery welding system according to an embodiment.

FIG. 7 is a perspective view showing a component part loading module applied to a battery welding system according to an embodiment.

FIG. 8 is a perspective view showing a component part unloading module applied to a battery welding system according to an embodiment.

FIGS. 9 and 10 are drawings schematically illustrating a fire extinguishing material storage tank applied to a battery welding system according to an embodiment.

FIG. 11 is a flowchart showing a battery welding method by using a battery welding system according to an embodiment.

FIG. 12 is a drawing schematically illustrating a fire extinguishing air bag module applied to a battery welding system according to an embodiment.

It should be understood that the above-referenced drawings are not necessarily to scale, presenting a somewhat simplified representation of various preferred features illustrative of the basic principles of the disclosure. The specific design features of the present disclosure, including, for example, specific dimensions, orientations, locations, and shapes, will be determined in part by the particular intended application and use environment.

### DETAILED DESCRIPTION OF THE EMBODIMENTS

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

The present disclosure will be described more fully hereinafter with reference to the accompanying drawings, in which embodiments of the disclosure are shown. As those skilled in the art would realize, the described embodiments may be modified in various different ways, all without departing from the spirit or scope of the present disclosure.

In order to clarify the present disclosure, parts that are not related to the description will be omitted, and the same elements or equivalents are referred to with the same reference numerals throughout the specification.

Also, the size and thickness of each element are arbitrarily shown in the drawings, but the present disclosure is not necessarily limited thereto, and in the drawings, the thickness of layers, films, panels, regions, etc., may be exaggerated for clarity.

The terminology used herein is for the purpose of describing specific examples only and is not intended to be limiting of the disclosure. As used herein, the singular forms are intended to include the plural forms as well, unless the context clearly indicates otherwise.

The term “coupled” denotes a physical relationship between two components in which components are directly connected to each other or indirectly through one or more intermediary components.

Hereinafter, an example of the present disclosure is described in detail with reference to the accompanying drawing.

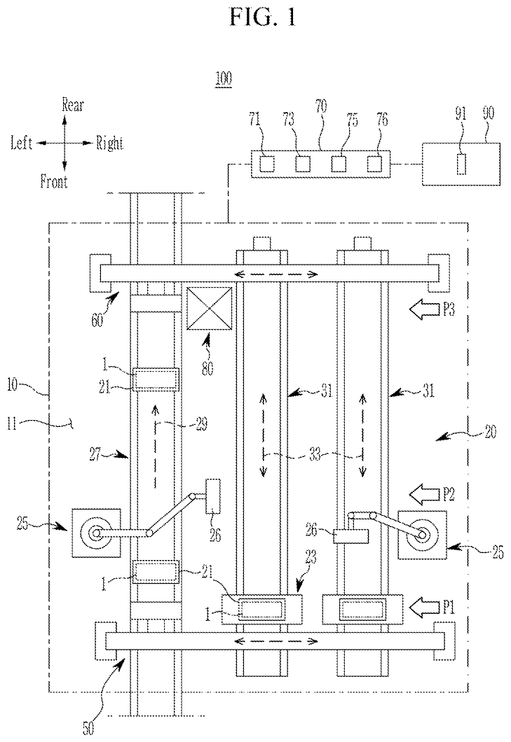

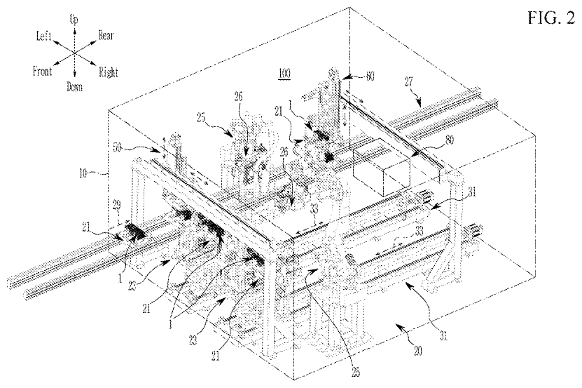

FIG. 1 is a block diagram schematically illustrating a battery welding system according to an embodiment. FIG. 2 is a perspective view showing a battery welding system according to an embodiment.

Referring to FIGS. 1 and 2, a battery welding system 100 according to an embodiment may be applied to a battery assembly process of assembling a battery pack assembly (BPA) to be installed in an electric vehicle.

Here, the battery pack assembly may include a battery module assembly (BMA) in which a plurality of battery cells are stacked. The battery pack assembly may include a pack assembly in which a plurality of battery module assemblies are electrically connected.

In addition, the battery welding system 100 according to an embodiment may be applied to a process for assembling the battery module assembly.

Furthermore, the battery welding system 100 according to an embodiment may be applied to a battery welding process for welding the battery module assembly (hereinafter also referred to as a battery component part 1 for convenience).

The welding process described above is a post-process after a battery cell stacking process (or alignment process) among a plurality of processes for assembling the battery pack assembly, and laser welding of the battery component part 1 may be performed.

The battery welding system 100 according to an embodiment may be configured in each of a plurality of welding process areas in a battery assembly plant.

In this disclosure, reference directions for describing the following components may include, in an example, a front-and-rear direction (for example, a process direction), a left-and-right direction (for example, a direction perpendicular to the process direction), and a vertical direction (for example, a height direction).

The definition of the directions as described above has a relative meaning, and since the direction may vary depending on the reference position of the components constituting the system 100 and the transfer direction of the battery component part 1, the reference directions may not necessarily be limited to the reference directions of the embodiment.

Furthermore, in this specification, “upper end portion”, “upper portion”, “upper end”, or “upper portion surface” of a component indicates end portion, portion, end, or surface of the component that is relatively positioned higher in the drawing, and “lower end portion”, “lower portion”, “lower end”, or “lower portion surface” of a component indicates end portion, portion, end, or surface of the component that is relatively positioned lower in the drawing.

In addition, in this specification, “end” (for example, one end, another end, or the like) of a component indicates an end of the component in any direction, and “end portion” (for example, one end portion, another end portion, or the like) of a component indicates a certain part of the component including the end.

The battery welding system 100 according to an embodiment is structured to automatically discharge the battery component part 1 on which the fire has occurred to extinguish the fire when fire occurs in the battery component part 1 during the welding process of the battery component part 1.

For such a purpose, the battery welding system 100 according to an embodiment includes a welding booth 10, a welding unit 20, a component part loading module 50, a component part unloading module 60, a fire detection unit 70, a fire extinguishing material storage tank 80, and a controller 90.

In an embodiment, the welding booth 10 is installed on a work area floor of the plurality of welding process areas. The welding booth 10 forms a predetermined interior space 11.

Here, the welding booth 10 may include a component part inlet (not shown) through which the battery component part 1 may enter the interior space 11 and a component part outlet (not shown) through which the battery component part 1 may be discharged from the interior space 11.

In an embodiment, the welding unit 20 is configured to perform a welding process of laser welding the battery component part 1 transported along a predetermined transport path. The welding unit 20 is installed in an interior of the welding booth 10.

The welding unit 20 includes a component part pallet 21, a clamping jig 23, and a welding robot 25.

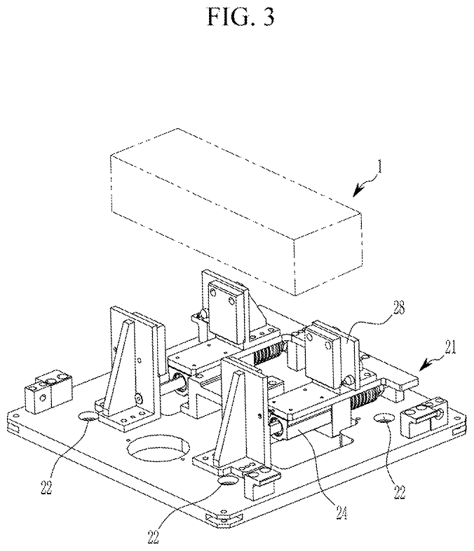

FIG. 3 is a perspective view showing a component part pallet of a welding unit applied to a battery welding system according to an embodiment.

Referring to FIGS. 1-3, the component part pallet 21 is configured to fix the battery component part 1, as shown in FIG. 3.

In an example, the component part pallet 21 may be formed in a plate shape on which the battery component part 1 is seated. A support hole 22 may be formed at a corner portion of the component part pallet 21. Furthermore, the component part pallet 21 moves along a guide device by an operation of a motor 24, and includes a component part fixing portion 28 configured to fix the battery component part 1.

Here, the component part pallet 21 may be transported along the front-and-rear direction in the interior of the welding booth 10 by a main conveyor 27. The main conveyor 27 is configured to perform a predetermined work process (for example, a stacking process, a welding process, and the like of the battery cell).

The main conveyor 27 may transport the battery component part 1 from the front to the rear along predetermined first transport path 29, in the welding process. At this time, the battery component part 1 is in a state of being mounted on the component part pallet 21, and may be transported from the front to the rear together with the component part pallet 21 in the interior of the welding booth 10 by the main conveyor 27. Hereinafter, for convenience of description, the component part pallet 21 may include a state of mounting the battery component parts 1.

The main conveyor 27 may include a belt that is operated by a main driving portion (for example, electric motor) (not shown). Furthermore, the main conveyor 27 may be disposed to penetrate the welding booth 10 along the first transport path 29.

The clamping jig 23 is configured to clamp the component part pallet 21. The clamping jig 23 may clamp not only the component part pallet 21 but also the battery component part 1 mounted on the component part pallet 21. The clamping jig 23 may be transported in the front-and-rear direction in the interior of the welding booth 10 by an auxiliary conveyor 31.

The auxiliary conveyor 31 is disposed in parallel with the main conveyor 27 in the interior of the welding booth 10. The auxiliary conveyor 31 may transport the clamping jig 23 forward and backward along a second transport path 33 parallel to the first transport path 29 of the main conveyor 27. In an example, the auxiliary conveyor 31 may be provided in the interior of the welding booth 10 in a quantity of at least two. However, the scope of the present disclosure is not limited thereto.

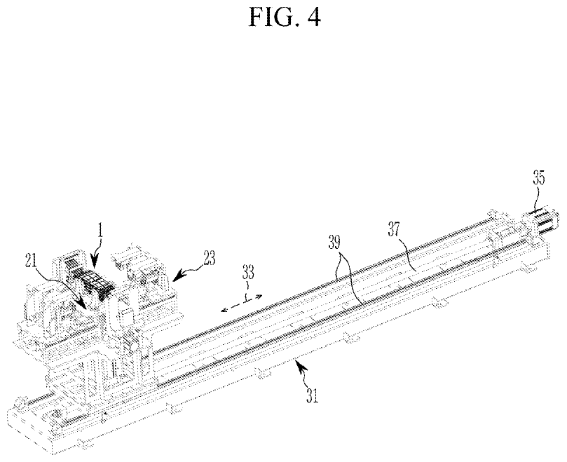

FIG. 4 is a perspective view showing an auxiliary conveyor of a welding unit 12′ applied to a battery welding system according to an embodiment.

Referring to FIG. 4, the auxiliary conveyor 31 includes an auxiliary driving portion 35 configured to generate power, a lead screw 37 connected to a rotation shaft of the auxiliary driving portion 35, and a pair of linear motion (LM) guides 39 configured to guide the clamping jig 23.

The auxiliary driving portion 35 may be a servo-motor configured to generate driving power, and may be disposed between the pair of LM guides 39. The lead screw 37 (alternatively, ball screw) may be integrally connected to the rotation shaft of the auxiliary driving portion 35, and screw-engaged with the clamping jig 23.

Therefore, when the lead screw 37 rotates by the power of the auxiliary driving portion 35, the clamping jig 23 screw-engaged with the lead screw 37 may move forward and backward the axial direction of along the lead screw 37.

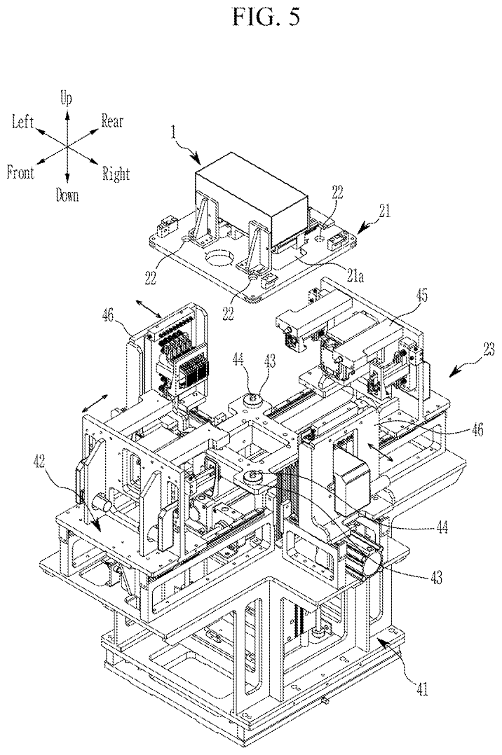

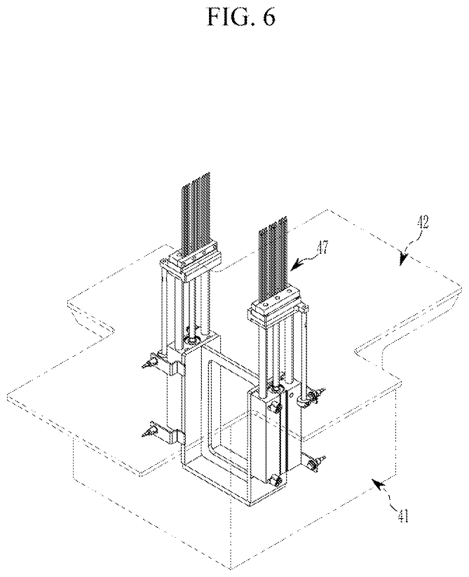

FIGS. 5 and 6 are perspective views showing a clamping jig of a welding unit applied to a battery welding system according to an embodiment.

Referring to FIGS. 4-6, the clamping jig 23 includes a mobile plate 41, a support plate 42 disposed on an upper portion of the mobile plate 41, a pair of first pressurizing jigs 45 movably disposed in the front-and-rear direction of the support plate 42, a pair of second pressurizing jigs 46 movably disposed in the left-and-right direction of the support plate 42, and a backup jig 47 disposed at a side surface of the support plate 42 to be movable in the vertical direction.

A central lower portion of the mobile plate 41 is screw-engaged with the lead screw 37 of the auxiliary conveyor 31. When power is generated from the auxiliary driving unit 35, the moving plate 41 moves along the second transport path 33 of the auxiliary conveyor 31 by rotation of the lead screw 37.

Here, since both lower portions of the movable plate 41 are guided by the pair of LM guides 39, stable movement of the movable plate 41 in the front-and-rear direction is ensured.

The component part pallet 21 on which the battery component part 1 is mounted may be seated on the support plate 42. To accurately position the component part pallet 21, a plurality of support pads 43 and a plurality of support protrusions 44 are formed on an upper surface of the support plate 42.

A bottom surface of the component part pallet 21 is seated on the plurality of support pads 43. Thus, the height direction position of the component part pallet 21 may be accurately determined. In an example, four support pads 43 may be formed at each corner of the support plate 42.

The plurality of support protrusions 44 may protrude upward from the plurality of support pads 43. In an example, the plurality of support protrusions 44 may be provided as a pair of support protrusions 44 formed along a diagonal direction of the support plate 42. Here, the support holes 22 corresponding to the plurality of support protrusions 44 may be formed in the component part pallet 21.

The pair of first pressurizing jigs 45 may pressurize the battery component part 1 on the component part pallet 21 seated on the support plate 42, in the front-and-rear direction. For this purpose, the pair of first pressurizing jigs 45 is movably provided in the upper portion of the mobile plate 41 (alternatively, front and rear portions of the support plate 42). The pair of first pressurizing jigs 45 may move in the front-and-rear direction by the power generated by the first cylinder. The first cylinder may include a hydraulic pressure cylinder or a pneumatic cylinder.

The pair of second pressurizing jigs 46 may pressurize the battery component part 1 on the component part pallet 21 seated on the support plate 42, in the left-and-right direction. For this purpose, the pair of second pressurizing jigs 46 is movably provided in the upper portion of the mobile plate 41 (alternatively, left and right side portions of the support plate 42). The pair of second pressurizing jigs 46 may move in the left-and-right direction by the power generated by the second cylinder. The second cylinder may include a hydraulic pressure cylinder or a pneumatic cylinder.

The backup jig 47 may fix the component part pallet 21 to the support plate 42 for stable restraint of the component part pallet 21 seated on the support plate 42. For this purpose, the backup jig 47 is provided on the mobile plate 41 to be movable in the vertical direction. The backup jig 47 may move in the vertical direction by the power generated by the backup cylinder. The backup cylinder may include a hydraulic pressure cylinder or a pneumatic cylinder. Here, a backup hole 21a corresponding to the backup jig 47 may be formed in the component part pallet 21, and the backup jig 47 may be inserted into the backup hole 21a to fix the component part pallet 21.

Referring to FIGS. 1 and 2, the welding robot 25 is configured to laser weld the battery component part 1 to the component part pallet 21 clamped by the clamping jig 23, on the auxiliary conveyor 31.

The welding robot 25 is installed in the interior of the welding booth 10. In an example, the welding robot 25 may be provided in a quantity of at least two, in the vicinity of two auxiliary conveyors 31.

The welding robot 25 may laser weld the battery component part 1 through a welder 26 mounted on a front end of a robot arm. In an example, the welding robot 25 may be provided as a 6-axis articulated robot.

Referring to FIGS. 1 and 2, in an embodiment, the component part loading module 50 and the component part unloading module 60 are respectively configured to load and unload the battery component part 1 at a predetermined component part loading position P1 and a component part unloading position P2 of the first transport path 29 and the second transport path 33.

The component part loading module 50 may transport, at the component part loading position P1, the component part pallet 21 transported along the first transport path 29 of the main conveyor 27 to the clamping jig 23 on the auxiliary conveyor 31.

In addition, the component part unloading module 60 may transport the battery component part 1 on which welding process is completed on the auxiliary conveyor 31 by the welding robot 25, together with the component part pallet 21, from the clamping jig 23 to the main conveyor 27, at the component part unloading position P2.

The component part loading module 50 and the component part unloading module 60 are installed in the interior of the welding booth 10. Hereinafter, configurations of the component part loading module 50 and the component part unloading module 60 according to an embodiment will be described in detail with reference to the accompanying drawings.

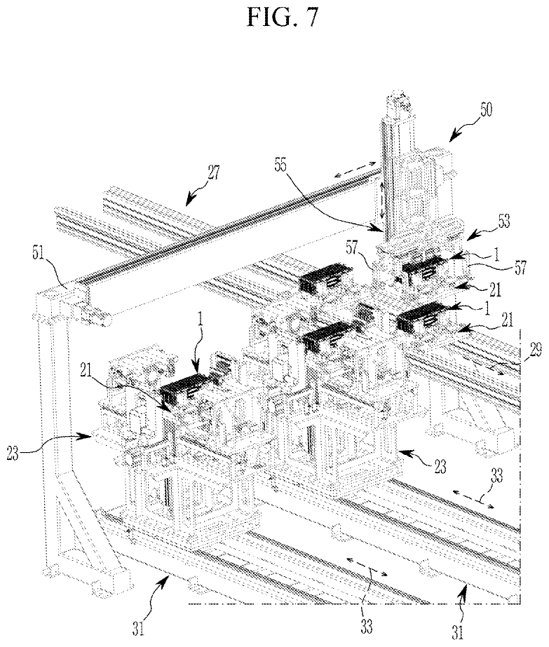

FIG. 7 is a perspective view showing a component part loading module applied to a battery welding system according to an embodiment.

Referring to FIGS. 1 and 7, the component part loading module 50 is installed at a front portion in the interior of the welding booth 10. The component part loading module 50 includes a loading gripper 53 disposed on a front frame 51 to be movable in a predetermined direction.

The loading gripper 53 may be moved in the left-and-right direction and the vertical direction by a first driving portion 55 installed in the front frame 51. The first driving portion 55 may include a first mobile member moved on a first rail disposed on the front frame 51 in the left-and-right direction by a first servo-motor along the left-and-right direction, and a second mobile member moved on a second rail disposed on the first mobile member in the vertical direction by a second servo-motor along the vertical direction. Since the first driving unit 55 is well known as a two-axis orthogonal robot to those skilled in the art, it will not be described in further detail.

The loading gripper 53 is coupled to the second mobile member, and moves along the left-and-right direction and the vertical direction. The loading gripper 53 may grip the component part pallet 21 transported to the component part loading position P1 along the first transport path 29 of the main conveyor 27, and may be unloaded to the clamping jig 23 on the auxiliary conveyor 31.

The loading gripper 53 includes a pair of first gripper bodies 57. The pair of first gripper bodies 57 may move in a direction closer to or away from by a first gripping cylinder, and may grip or un-grip the component part pallet 21. The first gripping cylinder may include a hydraulic pressure cylinder or a pneumatic cylinder.

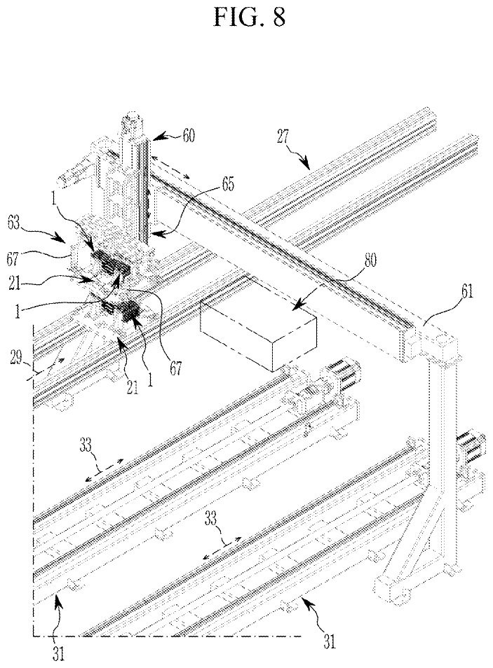

FIG. 8 is a perspective view showing a component part unloading module applied to a battery welding system according to an embodiment.

Referring to FIGS. 1 and 8, the component part unloading module 60 is installed at a rear portion in the interior of the welding booth 10. The component part unloading module 60 includes an unloading gripper 63 disposed on the rear frame 61 to be movable in a predetermined direction.

The unloading gripper 63 may be moved in the left-and-right direction and the vertical direction by a second driving portion 65 installed in the rear frame 61. The second driving portion 65 may include a third mobile member moved on the first rail disposed on the rear frame 61 in the left-and-right direction by the first servo-motor along the left-and-right direction, and a fourth mobile member moved on the second rail disposed on the third mobile member in the vertical direction by the second servo-motor along the vertical direction. Since the second driving unit 65 is well known as a two-axis orthogonal robot to those skilled in the art, it will not be described in further detail.

The unloading gripper 63 is coupled to the fourth mobile member, and moves along the left-and-right direction and the vertical direction. The unloading gripper 63 may grip, together with the component part pallet 21, the battery component part 1 completed with welding process on the auxiliary conveyor 31 to unload from the clamping jig 23, and transport the component part pallet 21 to the main conveyor 27 at the component part unloading position P2.

The unloading gripper 63 includes a pair of second gripper bodies 67. The pair of second gripper bodies 67 may move in a direction closer to or away from by a second gripping cylinder, and may grip or un-grip the component part pallet 21. The second gripping cylinder may include a hydraulic pressure cylinder or a pneumatic cylinder.

Referring to FIG. 1, in an embodiment, the fire detection unit 70 is configured to detect a fire occurring in the battery component part 1. Here, the fire of the battery component part 1 may be caused by an electrical short or welding heat in a welding process.

The fire detection unit 70 is installed in the interior of the welding booth 10. The fire detection unit 70 may detect the fire occurring in the battery component part 1 and output a detection signal to a controller 90 to be described later.

In an example, the fire detection unit 70 may include at least one flame detecting sensor 71, at least one smoke detecting sensor 73, and at least one thermal imaging camera 75 that are installed on the interior surface of the welding booth 10, respectively.

Furthermore, the fire detection unit 70 may further include a CCTV 76 installed on the interior surface of the welding booth 10. The CCTV 76 may be provided to track the history of fire occurrence of the battery component part 1.

The CCTV 76 may photograph the fire occurring in the battery component part 1 during the welding process. Image information photographed by the CCTV 76 may be stored in a controller 90 or a server (not shown) to be described later.

Referring to FIGS. 1 and 2, in an embodiment, the fire extinguishing material storage tank 80 is configured to fire-extinguish the battery component part 1 by the component part unloading module 60 when fire occurs in the battery component part 1.

Here, the battery component part 1 on which the fire has occurred may be transported to the component part unloading position P2 along the second transport path 33 of the auxiliary conveyor 31.

That is, the battery component part 1 on which the fire has occurred is in a state of being clamped by the clamping jig 23 together with the component part pallet 21, and may be moved to the component part unloading position P2 by the clamping jig 23 transported along the second transport path 33.

Also, the clamping jig 23 releases the clamping of the component part pallet 21 at the component part unloading position P2. Accordingly, the battery component part 1 on which the fire has occurred may be put (e.g., dropped) into the fire extinguishing material storage tank 80 together with the component part pallet 21 by the component part unloading module 60.

The component part unloading module 60 may be configured to unload the battery component part 1 on which the fire has occurred at the component part unloading position P2, and put the battery component part 1, together with the component part pallet 21, into an interior of the fire extinguishing material storage tank 80. Accordingly, the battery component part 1 on which the fire has occurred may be fire-extinguished in the fire extinguishing material storage tank 80.

In the above, the fire extinguishing material storage tank 80 may be installed adjacent to the component part unloading position P2ed in in the interior of the welding booth 10.

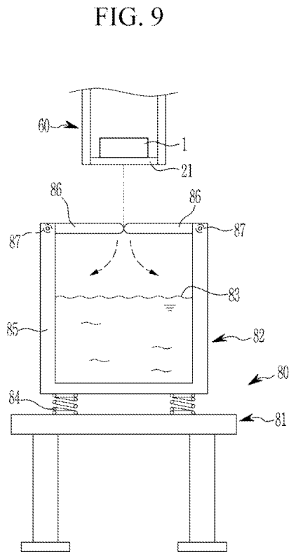

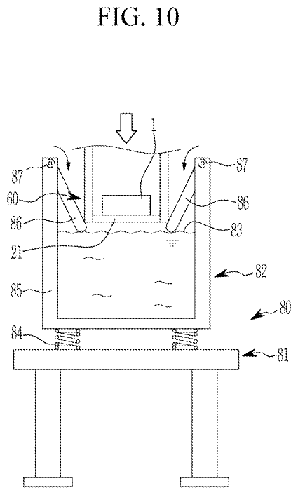

FIGS. 9 and 10 are drawings schematically illustrating a fire extinguishing material storage tank applied to a battery welding system according to an embodiment.

Referring to FIGS. 9 and 10, the fire extinguishing material storage tank 80 includes a base portion 81 and a tank portion 82.

The base portion 81 is provided in the form of a frame (for example, a supporting stand) and is installed on the floor inside the welding booth 10 (see FIG. 1).

The tank portion 82 is configured to store a fire extinguishing material 83. Here, the extinguishing material 83 may be in the form of liquid or powder, and may include saline in one example.

The tank portion 82 is installed in an upper portion of the base portion 81. Here, the battery component part 1 on which the fire has occurred may be put into an interior of the tank portion 82 by the component part unloading module 60, and submerged in the fire extinguishing material 83 in the interior of the tank portion 82.

The tank portion 82 may be installed on the upper surface of the base portion 81 through at least one support spring 84.

When the battery component part 1 on which the fire has occurred is put into the interior of the tank portion 82 by the component part unloading module 60, the at least one support spring 84 may buffer the load (for example, impact load) of the component part unloading module 60 or the component part pallet 21 acting on the tank portion 82.

The tank portion 82 includes a tank main body 85 and a pair of tank covers 86.

The tank main body 85 is designed to accommodate a predetermined amount of extinguishing material 83. The tank main body 85 is installed on the upper surface of the base portion 81 through at least one support spring 84.

The pair of tank covers 86 may open and close an open upper end of the tank main body 85. When the battery component part 1 on which the fire has occurred is put into an interior of the tank main body 85, the pair of tank covers 86 may prevent the fire extinguishing material 83 from overflowing from the interior to the exterior of the tank main body 85.

The pair of tank covers 86 may be rotatably installed in the vertical direction in an upper portion of the tank main body 85.

When the battery component part 1 on which the fire has occurred is put into the interior of the tank main body 85, the pair of tank covers 86 may rotate downward by the load of the component part pallet 21 or the component part unloading module 60, and may open the upper end of the tank main body 85.

In addition, when the component part unloading module 60 returns to its original position after putting the battery component part 1 on which the fire has occurred into the interior of the tank main body 85, the pair of tank covers 86 may rotate upward to close upper end of the tank main body 85.

For such a purpose, the tank portion 82 further includes a return spring 87. The return spring 87 is configured to rotate the pair of tank covers 86 rotated downward in the upward direction by an elastic force.

The return spring 87 is mounted in the upper portion of the tank main body 85, and connected to the pair of tank covers 86. The return spring 87 may be connected to the upper portion of the tank main body 85 and a rotation center portion of the pair of tank covers 86. In an example, the return spring 87 may include a torsion spring.

Referring to FIG. 1, in an embodiment, the controller 90 may control the overall operation of the battery welding system 100 according to an embodiment through a manufacturing execution system (MES).

The controller 90 may collect state information of the battery component part 1, and state information of the welding unit 20, the component part loading module 50, and the component part unloading module 60, and may control the overall welding process of the battery component part 1 based on the collected state information. 2′1

In addition, the controller 90 may control the welding unit 20, the component part loading module 50, and the component part unloading module 60, through at least one processor, for example, programmable logic controller (PLC), the operates by a predetermined program.

Furthermore, when the fire detection unit 70 detects the fire occurring at the battery component part 1, the controller 90 according to an embodiment may apply a predetermined control signal to the welding unit 20 and the component part unloading module 60.

That is, upon receiving the detection signal from the fire detection unit 70, when it is determined that fire has occurred in the battery component part 1, the controller 90 may apply the predetermined control signal to the clamping jig 23, the welding robot 25, and the auxiliary conveyor 31 of the welding unit 20 and the component part unloading module 60.

When the fire has occurred at the battery component part 1, the clamping jig 23 of the welding unit 20 and the welder 26 of the welding robot 25 may be moved to a predetermined evacuation position P3 of the second transport path 33 by the control signal provided from the controller 90. Here, the clamping jig 23 may be defined as a jig that is clamping the battery component part 1 on which the fire has not occurred.

In addition, when the fire has occurred at the battery component part 1, the clamping jig 23 having clamped the battery component part 1 on which the fire has occurred may be moved to predetermined component part unloading position P2 of the first transport path 29 and the second transport path 33 by the control signal provided from the controller 90.

In addition, when the fire has occurred at the battery component part 1, the component part unloading module 60 may grip the battery component part 1 on which the fire has occurred at the component part unloading position P2 by the control signal provided from the controller 90, transport it to the fire extinguishing material storage tank 80, and put it into the interior of the fire extinguishing material storage tank 80.

Furthermore, when it is determined that fire has occurred in the battery component part 1, the controller 90 may apply the predetermined control signal to the welding unit 20 and the component part unloading module 60, e.g., by a manipulation of a fire button 91 (for example, a button manipulation of the worker).

Hereinafter, the operation of the battery welding system 100 and battery welding method according to an embodiment configured as described above will be described in detail with reference to the accompanying drawings.

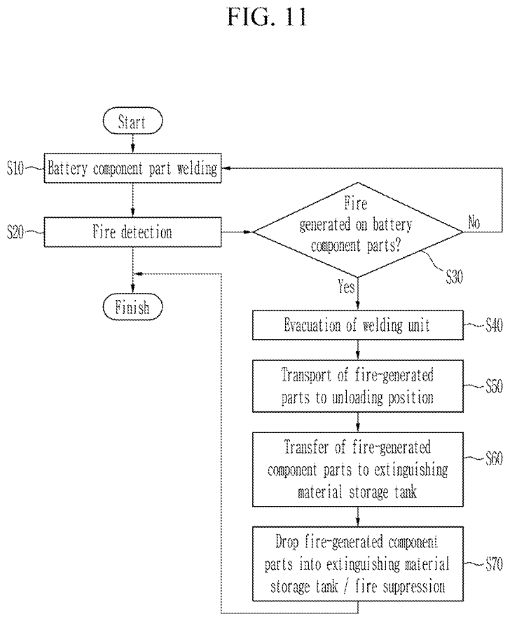

FIG. 11 is a flowchart showing a battery welding method by using a battery welding system according to an embodiment.

Referring to FIGS. 1-11, at step S10, the controller 90 applies the control signal to the welding unit 20, and instructs the welding of the battery component part 1 to the welding unit 20.

At the step S10, the battery component part 1 is in a state of being mounted on the component part pallet 21. The component part pallet 21 is in a state of being disposed at the component part loading position P1, for example, at a position adjacent to the clamping jig 23, by being transported along the first transport path 29 in the interior of the welding booth 10 by the main conveyor 27.

In addition, the clamping jig 23 is in a state of being disposed at a predetermined position, for example, at a position adjacent to the welding robot 25, by being transported along the second transport path 33 in the interior of the welding booth 10 by the auxiliary conveyor 31.

In such a state, the component part loading module 50 grips the component part pallet 21 together with the battery component part 1 at the component part loading position P1, and loads it to the clamping jig 23. Then, the clamping jig 23 clamps the component part pallet 21 and the battery component part 1.

Then, the welding robot 25 moves the welder 26 toward the battery component part 1 and laser welds the battery component part 1 through the welder 26.

Subsequently, the clamping jig 23 that is clamping the battery component part 1 completed with the welding together with the component part pallet 21 is transported along the second transport path 33 in the interior of the welding booth 10 by the auxiliary conveyor 31, and disposed at the component part unloading position P2.

Subsequently, the clamping jig 23 releases the clamping of the component part pallet 21 and the battery component part 1. Then, the component part unloading module 60 grips the component part pallet 21 together with the battery component part 1 at the component part unloading position P2, unloads it from the component part unloading position P2, and transport the component part pallet 21 to the main conveyor 27.

Therefore, at the step S10, a series of welding processes as described above are repeated, and a plurality of battery component parts 1 may be welded.

Meanwhile, at step S20, in the process of performing the welding process of the battery component part 1 as described above, the fire detection unit 70 detects the fire occurring in the battery component part 1, and outputs the detection signal to the controller 90.

At the step S20, the fire detection unit 70 may detect the fire occurring at the battery component part 1, through the at least one flame detecting sensor 71, the at least one smoke detecting sensor 73, and the at least one thermal imaging camera 75.

For example, the fire detection unit 70 may detect the fire occurring at the battery component part 1 clamped at the clamping jig 23 together with the component part pallet 21, in each of the two auxiliary conveyors 31.

Accordingly, at step S30, the controller 90 receives the detection signal output from the fire detection unit 70, and determines whether the fire has occurred at the battery component part 1. Furthermore, the controller 90 may also determine whether the fire has occurred, by the manipulation of the fire button 91.

Here, the fire may occur at the battery component part 1 clamped at the clamping jig 23 together with the component part pallet 21 on a first auxiliary conveyor 31 among the two auxiliary conveyors 31. In addition, the fire may occur at the battery component part I clamped at the clamping jig 23 together with the component part pallet 21 on a second auxiliary conveyor 31 among the two auxiliary conveyors 31. Furthermore, the fire may occur at the battery component parts 1 clamped at the clamping jig 23 together with the component part pallet 21 on the two auxiliary conveyors 31.

In this case, at the step S30, the controller 90 applies the predetermined control signal to the welding unit 20 when it is determined that fire has occurred in at least one battery component part 1.

Then, the one auxiliary conveyor 31 transports the clamping jig 23, which is clamping the battery component part 1 on which the fire has not occurred together with the component part pallet 21, to the predetermined evacuation position P3 of the second transport path 33. In addition, at step S40, the welding robot 25 moves (i.e., evacuates) the welder 26 to the evacuation position P3.

Simultaneously, at step S50, the second auxiliary conveyor 31 transports the clamping jig 23, which is clamping the battery component part 1 on which the fire has occurred together with the component part pallet 21, to predetermined component part unloading position P2 of the first transport path 29 and the second transport path 33.

At the step S50, when the fire has occurred at each of the battery component parts 1 clamped at the clamping jigs 23 together with the component part pallet 21 on the two auxiliary conveyors 31, the two auxiliary conveyors 31 may transport the respective clamping jigs 23 to the component part unloading position P2.

Here, the clamping jig 23 transported to the component part unloading position P2 releases the clamping of the component part pallet 21 and the battery component part 1.

In such a state, the controller 90 applies the predetermined control signal to the component part unloading module 60.

Then, at step S60, the component part unloading module 60 grips the battery component part 1 on which the fire has occurred together with the component part pallet 21 at the component part unloading position P2, unloads the component part pallet 21 from the component part unloading position P2, and transports it to the fire extinguishing material storage tank 80.

Subsequently, at step S70, the component part unloading module 60 un-grips the battery component part 1 on which the fire has occurred in the fire extinguishing material storage tank 80, and thereby puts (i.e., drops) it into the interior of the tank portion 82, together with the component part pallet 21.

At the step S70, by the load of the component part unloading module 60 or the component part pallet 21, the pair of tank covers 86 of the tank portion 82 overcomes the elastic force of the return spring 87 to rotate in the downward direction, thereby opening the upper end of the tank main body 85. At this time, the at least one support spring 84 buffers the impact load of the component part unloading module 60 or the component part pallet 21 applied to the tank portion 82.

In addition, when the battery component part 1 on which the fire has occurred is put into the interior of the tank main body 85 together with the component part pallet 21, the pair of tank covers 86 rotates upward by the elastic restoring force of the return spring 87 to close the upper end of the tank main body 85.

Accordingly, when the battery component part 1 on which the fire has occurred is put into the interior of the tank main body 85, the pair of tank covers 86 may prevent the fire extinguishing material 83 from overflowing from the interior to the exterior of the tank main body 85.

As described above, when the battery component part 1 on which the fire has occurred is put into the interior of the tank main body 85 together with the component part pallet 21, the battery component part 1 on which the fire has occurred is submerged in the fire extinguishing material 83, and the fire on the battery component part 1 is suppressed by the fire extinguishing material 83.

Accordingly, the battery welding system 100 according to an embodiment may extinguish the fire having occurred on the battery component part 1 during the welding process through a series of fire suppression processes as described above.

According to the battery welding system 100 according to an embodiment as described above, during the welding process, the battery component part 1 on which the fire has occurred may be automatically discharged to be put into the fire extinguishing material storage tank 80, and the fire on the battery component part 1 may be suppressed.

Therefore, the battery welding system 100 according to an embodiment may shorten an initial fire extinguishing period of the battery component part 1. Accordingly, the battery welding system 100 according to an embodiment may reduce the fire loss scale and the battery production loss scale of the battery welding equipment, and shorten non-operating time of the system.

In addition, according to the battery welding system 100 according to an embodiment, by automatically discharging the battery component part 1 on which the fire has occurred to extinguish the fire in the fire extinguishing material storage tank 80, secondary casualties such as toxic gas poisoning and burns to workers from fires may be prevented.

Furthermore, the battery welding system 100 according to an embodiment does not require a separate equipment for discharging the battery component part 1 on which the fire has occurred, and is capable of automatically discharging the battery component part 1 on which the fire has occurred by using existing equipment for the battery welding, which may minimize the equipment investment cost.

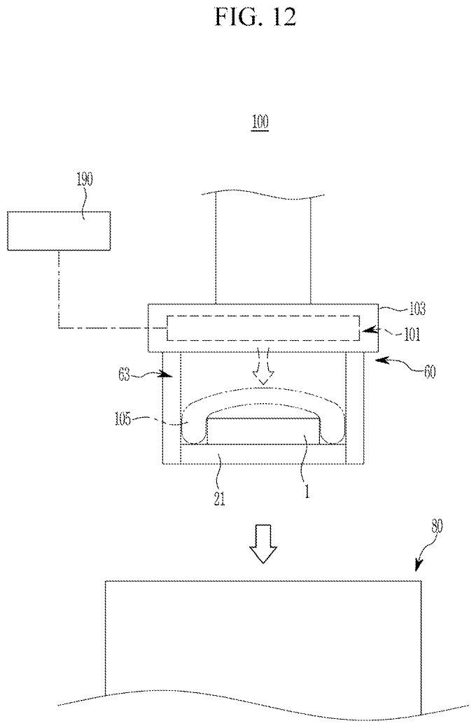

FIG. 12 is a drawing schematically illustrating a fire extinguishing air bag module applied to a battery welding system according to an embodiment.

Referring to FIG. 12, the battery welding system 100 according to an embodiment may further include a fire extinguishing air bag module 101 installed in the component part unloading module 60.

The fire extinguishing air bag module 101 may be installed in a gripper mounting portion 103 in which the unloading gripper 63 is mounted, in the component part unloading module 60.

The fire extinguishing air bag module 101 may include a fire extinguishing air bag 105 configured to deployed upon receiving the control signal from a controller 190 when the fire occurs at the battery component part 1.

In an example, the fire extinguishing air bag 105 is formed of a fireproof material and may cover the battery component part 1 on which the fire has occurred while being deployed by the explosive force of sodium azide.

Here, the fire extinguishing air bag 105 may be deployed at a time point of unloading the battery component part 1 on which the fire has occurred through the component part unloading module 60, and may cover the battery component part 1 until the battery component part 1 is put into the fire extinguishing material storage tank 80 through the component part unloading module 60.

Therefore, when the battery component part 1 on which the fire has occurred is discharged to be put into the fire extinguishing material storage tank 80, the fire extinguishing air bag module 101 may deploy the fire extinguishing air bag 105 to cover the battery component part 1, which further shorten the initial fire extinguishing period of the battery component part 1.

While this disclosure has been described in connection with what is presently considered to be practical embodiments, it is to be understood that the disclosure is not limited to the disclosed embodiments. On the contrary, it is intended to cover various modifications and equivalent arrangements included within the spirit and scope of the appended claims.

What is claimed is:

1. A battery welding system, comprising:
a welding booth;
a welding unit installed in an interior of the welding booth and configured to weld a battery component part transported along a predetermined transport path;
a component part loading module and a component part unloading module each installed in the interior of the welding booth and configured to load and unload the battery component part at a predetermined part loading position and a part unloading position of the transport path, respectively; and
a fire detection unit configured to detect occurrence of a fire in the battery component part.

2. The battery welding system of claim 1, wherein the fire detection unit comprises at least one flame detecting sensor, at least one smoke detecting sensor, and at least one thermal imaging camera that are installed on an interior surface of the welding booth.

3. The battery welding system of claim 2, wherein the fire detection unit further comprises a CCTV installed on the interior surface of the welding booth.

4. The battery welding system of claim 1, further comprising:
a fire extinguishing material storage tank installed adjacent to a predetermined part unloading position of the transport path within the interior of the welding booth.

5. The battery welding system of claim 4, wherein the fire extinguishing material storage tank comprises:
a base portion installed at a bottom in the interior of the welding booth; and
a tank portion installed in an upper portion of the base member and configured to store the fire extinguishing material.

6. The battery welding system of claim 5, wherein the tank portion is installed in an upper surface of the base portion through at least one support spring.

7. The battery welding system of claim 5, wherein the tank portion comprises:
a tank main body configured to accommodate the fire extinguishing material; and
a pair of tank covers rotatably installed in a vertical direction in an upper portion of the tank main body.

8. The battery welding system of claim 7, wherein the tank portion further comprises a return spring mounted in the tank main body, and connected to the pair of tank covers.

9. The battery welding system of claim 4, wherein:
a battery component part on fire is transported to the predetermined part unloading position through the transport path; and
the component part unloading module is configured to unload the battery component part on fire at the predetermined part unloading position, and to put the battery component part into an interior of the fire extinguishing material storage tank.

10. The battery welding system of claim 1, further comprising a controller configured to apply a control signal to the welding unit and the component part unloading module when it is determined by the fire detection unit that fire has occurred in the battery component part.

11. The battery welding system of claim 10, wherein:
the welding unit is moved to an evacuation position predetermined on the transport path; and
a battery component part on fire is moved to the predetermined part unloading position of the transport path.

12. The battery welding system of claim 11, wherein the component part unloading module is configured to grip the battery component part on fire at the predetermined part unloading position, transport the battery component part to a fire extinguishing material storage tank, and put the battery component part into an interior of the fire extinguishing material storage tank.

13. The battery welding system of claim 10, wherein the controller is configured to apply the control signal to the welding unit and the component part unloading module when it is determined by manipulation of a fire button that fire has occurred in the battery component part.

14. The battery welding system of claim 10, further comprising a fire extinguishing air bag module installed in the component part unloading module, and configured to receive the control signal from the controller and deploy an air bag.

15. The battery welding system of claim 1, wherein the fire detection unit is installed in the welding booth.

16. The battery welding system of claim 1, wherein the welding unit comprises:
a component part pallet that is transported along a main conveyor in the interior of the welding booth, and on which the battery component part is mounted;
a clamping jig transported along an auxiliary conveyor in the interior of the welding booth, and configured to clamp the component part pallet; and
a welding robot installed in the interior of the welding booth and configured to weld the battery component part on the component part pallet clamped in the clamping jig.

17. The battery welding system of claim 16, wherein:
the main conveyor is disposed to penetrate the welding booth along the predetermined transport path; and
the auxiliary conveyor is disposed in parallel with the main conveyor in the interior of the welding booth.

18. The battery welding system of claim 16, wherein:
the component part loading module is configured to transport the component part pallet transported along the main conveyor to the clamping jig on the auxiliary conveyor; and
the component part unloading module is configured to transport the battery component part on which a welding process is completed on the auxiliary conveyor by the welding robot to the main conveyor together with the component part pallet.

19. The battery welding system of claim 16, wherein the auxiliary conveyor is provided in the interior of the welding booth in a quantity of at least two.

20. A system for assembling a battery pack for an electric vehicle comprising the battery welding system of claim 1.
